(19) United States
(12) Patent Application Publication
(10) Pub. No.: US 2023/0168144 A1
(43) Pub. Date: Jun. 1, 2023

(54) DETERMINING THE FLUID DENSITY IN AN ELECTRICAL DEVICE

(71) Applicant: Siemens Energy Global GmbH & Co. KG, München (DE)

(72) Inventors: Matthias Heinecke, Berlin (DE); Mario Pilz, Berlin (DE)

(21) Appl. No.: 17/918,264

(22) PCT Filed: Mar. 11, 2021
(86) PCT No.: PCT/EP2021/056132

§ 371 Date: Oct. 11, 2022

(30) Foreign Application Priority Data
Apr. 9, 2020 (DE) 10 2020 204 624.7

(51) Int. Cl. G01M 3/32; G06N 3/044

(52) U.S. Cl. CPC G01M 3/3272; G06N 3/044; H02B 13/00

(57) ABSTRACT

In a method for determining a fluid density of a fluid in an encapsulated electrical device a sensor unit is used to acquire measurement data. The fluid density is derived from the measurement values. Weather data relating to weather conditions in an environment of the electrical device are collected. Via machine learning, a digital model is generated for the influence of the weather conditions on a measurement deviation of a measurement value from the true fluid density. Using the digital model, a correction value is calculated for measurement values according to the weather data and a measurement value is corrected using the correction value.

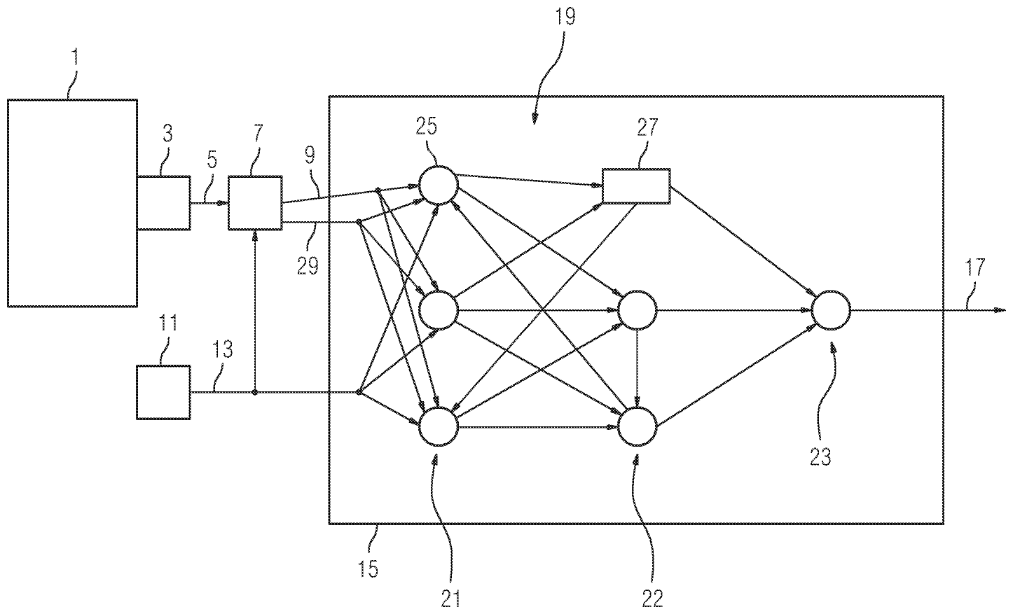

The invention relates to a method for determining a fluid density of a fluid in an encapsulated electrical device.

Many electrical devices are at least partially filled with a fluid, that is, a gas or a liquid, as an insulating medium, for example to increase the electrical dielectric strength in an electrical device, to suppress arcs in an electrical device, and/or to cool an electrical device. For example, gas-insulated switchgear is filled with a pressurized insulating gas such as sulfur hexafluoride or air, and transformers are often filled with transformer oil. The fluid density of the fluid in the electrical device is often an important and critical quantity, in particular for the operational safety of the electrical device. For example, the dielectric strength of an insulating gas in a gas-insulated switchgear system depends crucially on the gas density of the insulating gas. Moreover, an escape of insulating gas such as sulfur hexafluoride from a gas-insulated switchgear may result in financial penalties for the operator of the switchgear due to the harmful effects of the insulating gas on the environment.

The fluid density in an electrical device is therefore normally monitored to detect a leakage of fluid from the electrical device and, if necessary, to counteract a change in fluid density or to switch off the electrical device for safety reasons in the event of a critical change in the fluid density. The measurement accuracy of fluid density measurement in an electrical device is subject to fluctuations, which can be caused in particular by external weather effects. This limits the detection of changes in fluid density, in particular in short periods of time. The influence of changing weather conditions on the measurement results of fluid densities is usually only acquired and evaluated over long observation windows (several weeks or months), which enables long-term trends to be calculated.

The object of the invention is to improve the determination of a fluid density of a fluid in an encapsulated electrical device, in particular in order to reliably detect changes in fluid density even over short periods.

This object is achieved according to the invention by a method having the features of claim 1, a computer program having the features of claim 14, and an electrical device having the features of claim 15.

Advantageous configurations of the invention are the subject matter of the dependent claims.

The method according to the invention for determining a fluid density of a fluid in an encapsulated electrical device uses a sensor unit to acquire measurement data from which measurement values for the fluid density are derived and to collect weather data on weather conditions in an environment of the electrical device. Machine learning is used to generate a digital model for the influence of weather conditions on the measurement deviation of a measurement value from the true fluid density. Using the digital model, a correction value for measurement values is calculated as a function of the weather data and a measurement value is corrected with the correction value.

The method according to the invention thus enables a correction of measurement values of the fluid density, which takes into account effects of weather conditions in an environment of the electrical device. For this purpose, machine learning is used to train a digital model which models the influence of weather conditions on the measurement deviation of the measurement values. This means that, in particular, even short-term effects of the weather conditions on the measurement of the fluid density can be taken into account, which significantly improves the accuracy of the fluid density measurement and enables changes in fluid density, for example, as a result of fluid losses due to leaks in the electrical device, to be quickly and reliably detected. In particular, this increases the operational safety of the electrical device and improves the maintainability of the electrical device.

In one embodiment of the method according to the invention, the digital model comprises an artificial neural network having a plurality of layers of networked artificial neurons. Preferably, the artificial neural network is a recurrent artificial neural network and/or has at least one memory-enabled cell. A recurrent artificial neural network is understood to be a feedback artificial neural network, the neurons of which are networked in deepening layers with connections from neurons of one layer not only to neurons of a deeper layer, but also to neurons of the same or a higher layer. A memory-enabled cell is understood to mean a cell with a so-called long short-term memory (LSTM), in other words, a cell with a kind of long-lasting short-term memory. Such cells are also called LSTM cells and an artificial neural network with LSTM cells is also called an artificial neural LSTM network. Artificial neural networks with many layers are extremely capable of learning. The LSTM technology ensures good, stable functioning of such artificial neural networks and the recurrent interconnection of neurons makes it possible, among other benefits, to discover and evaluate sequenced information in the data processed by the artificial neural network. Recurrent artificial neural LSTM networks have already been successfully used in many areas, such as handwriting recognition, speech recognition, and machine translation of texts into different languages. The method according to the invention makes profitable use of the capabilities of such artificial neural networks for the analysis and correction of measurement values of the fluid density as a function of weather data.

In a further embodiment of the method according to the invention, the measurement data and/or the measurement values are transferred to a data cloud (Cloud) and/or the correction value is calculated using the digital model in a data cloud. By transferring the measurement data and/or measurement values to a data cloud, this data can be provided and evaluated independently of location and user. The calculation of the correction values with the digital model in a data cloud advantageously allows the use of a high computing capacity that can be provided by a data cloud.

In another embodiment of the method according to the invention, in order to train the digital model, further training values for measurement values and/or weather data are generated from measurement values and/or weather data. For example, training values are generated by temporally shifting weather data relative to measurement values, scaling of measurement values and/or weather data, and/or shifts in the value range of the measurement values. In addition, training values for simulated fluid losses can be generated to train the digital model, for example by adding values from simulated trend curves to measurement values. These embodiments of the method according to the invention are particularly advantageous if there is initially an insufficient amount of suitable measurement values and/or weather data available for training the digital model. The embodiments provide for the generation of suitable additional training values from the (few) available measurement values and/or weather data, by means of so-called data augmentation and/or from simulated fluid losses.

In a further embodiment of the method according to the invention, a calculation period, for example a period of 24 hours, is specified and the correction value for measurement values that are acquired within the calculation period is calculated using the digital model. This makes it possible to keep the influence of weather conditions on the measurement values of the fluid density up-to-date and to compare them with the results for previous calculation periods, for example in order to detect trends in these results.

In a further embodiment of the method according to the invention, the weather data comprises a temperature, a wind speed, precipitation, an air humidity and/or an air pressure in the environment of the electrical device. This embodiment of the method according to the invention advantageously takes into account weather conditions that exert the most influence on the measurement of the fluid density.

In a further embodiment of the method according to the invention, the digital model is generated specifically for an electrical device. Alternatively, the digital model is created for separate electrical devices that are similar to each other. The generation of a digital model for only one particular electrical device allows specific characteristics of the device to be taken into account. The generation of a digital model for a plurality of electrical devices that are similar to each other advantageously allows the model to be used for an entire class of electrical devices, thereby reducing the development effort and development costs of the measurement value correction according to the invention for these electrical devices compared to generating a special digital model for each of these devices.

In a further embodiment of the method according to the invention, only measurement values and weather data are fed into the digital model as input variables. This embodiment of the method according to the invention is particularly suitable for generating a digital model specifically for a particular electrical device. Alternatively, measurement values, weather data and additional data generated from the measurement values and weather data are supplied to the digital model as input variables. This alternative embodiment of the method according to the invention is particularly suitable for generating a digital model for a plurality of similar electrical devices. The additional data is used to take differences between the electrical devices into account. Additional data includes, for example, derivatives of measurement values according to weather data, which describe, for example, changes in measurement values as a function of the temperature or the air pressure in the environment of an electrical device.

A computer program according to the invention comprises commands, which during the execution of the computer program by a control unit or in a data cloud cause the latter to implement the digital model of a method according to the invention.

An electrical device according to the invention comprises a control unit on which a computer program according to the invention is executed, or a connection to a data cloud in which a computer program according to the invention is executed.

The properties, features and advantages of the present invention described above and the manner in which these are achieved will become clearer and more comprehensible with the following description of exemplary embodiments, which are explained in more detail in connection with the drawings.

The only FIGURE shows a structural diagram of an exemplary embodiment of the method according to the invention for determining a fluid density of a fluid in an encapsulated electrical device 1.

In the exemplary embodiment shown, measurement data 5 is acquired with a sensor unit 3 and from the measurement data 5, measurement values 9 for the fluid density are derived using a processing unit 7. In addition, weather data 13 provided by a weather data source 11 relating to weather conditions in an environment of the electrical device 1 is collected. Machine learning is used to generate a digital model 15 for the influence of the weather conditions on the measurement deviation of a measurement value 9 from the true fluid density. Using the digital model 15, a correction value 17 for measurement values 9 is calculated as a function of the weather data 13 and a measurement value 9 is corrected with the correction value 17.

For example, the electrical device 1 is a gas-insulated switchgear system and the fluid is a pressurized insulating gas in the gas-insulated switchgear system. Alternatively, the electrical device 1, for example, is an oil-filled transformer and the fluid is a transformer oil in the transformer. The invention is not restricted to a nature or type of the electrical device.

The sensor unit 3 is configured to acquire measurement data 5 from which measurement values 9 of the fluid density can be derived. For example, the sensor unit 3 has sensors that are configured to acquire a fluid pressure of the fluid and a fluid temperature of the fluid as measurement data 5. Alternatively, the sensor unit 3, for example, has two quartz oscillators, one quartz oscillator being operated in a controlled reference environment and the other quartz oscillator being operated in the fluid, and the sensor unit 3 detects resonance frequencies of the two quartz oscillators as measurement data 5. The invention is not restricted to a nature or type of the sensor unit 3.

The processing unit 7 determines a measurement value 9 for the fluid density from the measurement data 5. For example, if the measurement data 5 comprises a fluid pressure of the fluid and a fluid temperature of the fluid, the processing unit 7 calculates a measurement value 9 for the fluid density from the fluid pressure and the fluid temperature. For example, if the measurement data 5 comprises resonance frequencies of two quartz oscillators of a sensor unit 3 described above, the processing unit 7 calculates a measurement value 9 for the fluid density from the difference between the resonance frequency in the fluid and the resonance frequency in the reference environment. The invention is not restricted to a nature or type of the processing unit 7.

For example, the weather data source 11 is a weather station that collects the weather data 13. Alternatively, the weather data source 11 is a weather database, for example in a data cloud, that provides the weather data 13. The weather data source 11 can also comprise a weather station and such a weather database. The weather data 13 comprises, for example, a temperature, a wind speed, precipitation, an air humidity and/or an air pressure in the environment of the electrical device 1. The invention is not restricted to a nature or type of the weather data source 11.

The digital model 15 has an artificial neural network 19 having a plurality of layers 21, 22, 23 of networked artificial neurons 25 and memory-enabled cells 27 (LSTM cells). The neural network 19 is designed as a recurrent neural LSTM network. An arrow from a neuron 25 to another neuron 25 or to a memory-enabled cell 27 symbolizes that an output value of the neuron 25 is transferred to the other neuron 25 or to the memory-enabled cell 27 as an input value. Accordingly, an arrow from a memory-enabled cell 27 to a neuron 25 symbolizes that an output value of the memory-enabled cell 27 is transferred to a neuron 25 as an input value. The neural network 19 here is only shown schematically with an input layer 21, an intermediate layer 22, an output layer 23, and a memory-enabled cell 27. In an actual embodiment, the neuronal network 19 has considerably more intermediate layers 22, neurons 25 and memory-enabled cells 27 than are shown in the FIGURE.

As an option, in addition to the measurement values 9 and the weather data 13 supplied as input variables the digital model 15 is also supplied with additional data 29, which is generated by the processing unit 7 from the measurement values 9 and the weather data 13. The additional data 29 includes, for example, derivatives of measurement values according to weather data 13, which describe, for example, changes in measurement values 9 as a function of the temperature or the air pressure in the environment of an electrical device 1. Such additional data 29 is fed to the digital model 15 as input variables, in particular when the digital model 15 is not only generated specifically for a particular electrical device 1 but for separate (but similar to each other) electrical devices 1.

For example, the measurement data 5 and/or the measurement values 9 are transferred to a data cloud and/or the correction value 17 is calculated with the digital model 15 in a data cloud.

For training the digital model 15, further training values for measurement values 9 and/or weather data 13 can be generated from measurement values 9 and/or weather data 13 by means of so-called data augmentation, in particular if there is initially an insufficient amount of suitable measurement values 9 and/or weather data 13 available for training the digital model 15. For example, such training values are generated by temporally shifting weather data 13 relative to measurement values 9, scaling measurement values 9 and/or weather data 13, and/or shifts in the value range of the measurement values 9. In addition, training values for simulated fluid losses are generated to train the digital model 15.

For example, the digital model is used to calculate a correction value 17 for measurement values 9 which are acquired within a specified calculation period, for example a period of 24 hours.

Although the invention has been illustrated and described in greater detail by means of preferred exemplary embodiment, the invention is not restricted by the examples disclosed and other variations can be derived therefrom by the person skilled in the art without departing from the scope of protection of the invention.

1-15. (canceled)

16. A method for determining a fluid density of a fluid in an encapsulated electrical device, the method comprising:
acquiring measurement data by a sensor unit and deriving from the measurement data measurement values for the fluid density;
collecting weather data relating to weather conditions in an environment of the electrical device;
using machine learning to generate a digital model for an influence of the weather conditions on a measurement deviation of a measurement value from a true fluid density;
using the digital model to calculate a correction value for the measurement values as a function of the weather data; and
correcting a measurement value with the correction value.

17. The method according to claim 16, wherein the digital model comprises an artificial neural network having a plurality of layers of networked artificial neurons.

18. The method according to claim 17, wherein the artificial neural network is a recurrent artificial neural network.

19. The method according to claim 17, wherein the artificial neural network comprises at least one memory-enabled cell.

20. The method according to claim 16, which comprises transferring at least one of the measurement data or the measurement values to a data cloud, and/or calculating the correction value with the digital model in a data cloud.

21. The method according to claim 16, which comprises training the digital model by generating further training values for measurement values and/or weather data from measurement values and/or weather data.

22. The method according to claim 21, which comprises generating the training values by at least one of: temporally shifting weather data relative to measurement values, scaling measurement values and/or weather data, or shifting a value range of the measurement values.

23. The method according to claim 16, which comprises training the digital model by generating training values for simulated fluid losses.

24. The method according to claim 16, which comprises specifying a calculation period and calculating with digital model the correction value for the measurement values that are acquired within the calculation period is calculated.

25. The method according to claim 24, which comprises specifying a period of 24 hours for the calculation period.

26. The method according to claim 16, wherein the weather data are selected from the group consisting of a temperature, a wind speed, precipitation, an air humidity, and an air pressure in the environment of the electrical device.

27. The method according to claim 16, which comprises generating the digital model specifically for a given electrical device.

28. The method according to claim 16, which comprises generating the digital model for mutually different electrical devices.

29. The method according to claim 16, which comprises feeding only measurement values and weather data as input variables to the digital model.

30. The method according to claim 16, which comprises feeding measurement values, weather data, and additional data, generated from the measurement values and the weather data, as input variables to the digital model.

31. A computer program, comprising computer-executable commands which, when the commands are executed by a control unit or in a data cloud, implement the digital model of the method according to claim 16.

32. An electrical device with encapsulated fluid, the electrical device comprising:
a sensor unit for acquiring measurement data relating to a fluid density of the fluid;
a control unit or a connection to a data cloud;
a computer program residing in the control unit or in the data cloud, the computer program being configured to:
derive measurement values from the measurement data acquired by the sensor unit;
collect weather data relating to weather conditions in an environment of the electrical device;
use machine learning to generate a digital model for an influence of the weather conditions on a measurement deviation of the measurement values from a true fluid density of the fluid;
use the digital model to calculate correction values for the measurement values as a function of the weather data; and
correct the measurement values with the correction values.
